(19) United States
(12) Patent Application Publication
(10) Pub. No.: US 2015/0251263 A1
(43) Pub. Date: Sep. 10, 2015

(54) TWEEZERS DEVICE WITH FUNCTION OF INSTALLING SOLDERING IRON

(71) Applicant: Primax Electronics Ltd., Taipei (TW)

(72) Inventor: PEI-MING CHANG, Taipei (TW)

(21) Appl. No.: 14/305,912

(22) Filed: Jun. 16, 2014

(30) Foreign Application Priority Data
Mar. 7, 2014 (TW) 103107996

(51) Int. Cl. B23K 3/02; B23K 3/03

(52) U.S. Cl. CPC B23K 3/026; B23K 3/0369

(57) ABSTRACT

A tweezers device with a function of installing a soldering iron is provided. The tweezers device includes a first clipping structure and a second clipping structure. The second clipping structure is pivotally coupled to the first clipping structure. An object between a first clipping end of the first clipping structure and a second clipping end of the second clipping structure is clipped by the tweezers device. When the soldering tip is accommodated within an accommodation space of the second clipping structure, a soldering tip of the soldering iron is contacted with the second clipping end of the second clipping structure. Since the second clipping end of the second clipping structure is made of a thermal conductive material, a heat energy generated by the soldering iron is transferred to the second clipping end of the second clipping structure.

### FIELD OF THE INVENTION

The present invention relates to a tweezers device, and more particularly to a tweezers device with a function of installing a soldering iron.

### BACKGROUND OF THE INVENTION

Soldering irons are widely used in the soldering or desoldering processes of various electronic components. Hereinafter, the structure of a soldering iron will be illustrated with reference to FIGS. 1 and 2. FIG. 1 schematically illustrates a conventional soldering iron. FIG. 2 is a schematic exploded view illustrating the conventional soldering iron of FIG. 1. As shown in FIGS. 1 and 2, the conventional soldering iron 1 comprises a soldering iron handle 11, a tube carrier 12, a heating core 13, a tip enclosure 14, and a soldering tip 15. A first end of the tube carrier 12 is connected to the soldering iron handle 11. A second end of the tube carrier 12 is coupled with the tip enclosure 14 by a connection mechanism (e.g. a screwing connection mechanism). The soldering tip 15 comprises an installation terminal 151 and a tapered heating terminal 152. The installation terminal 151 is accommodated within the tip enclosure 14. The tapered heating terminal 152 is penetrated through the tip enclosure 14 and exposed outside the tip enclosure 14. Moreover, two perforations 141 are located at two opposite sides of the tip enclosure 14. Two screws 16 are respectively penetrated through the two perforations 141 and contacted with two opposite sides of the installation terminal 151 of the soldering tip 15. After the soldering tip 15 is fixed by the two screws 16, the soldering tip 15 is not detached from the tip enclosure 14.

Moreover, a heating element 111 and a power cord 112 are disposed within the soldering iron handle 11. The power cord 112 is electrically connected to the heating element 111. An end of the heating core 13 is fixed in the soldering iron handle 11 and electrically connected to the heating element 111. After the tube carrier 12 and the tip enclosure 14 are coupled with each other, the other end of the heating core 13 is contacted with the installation terminal 151 of the soldering tip 15. Moreover, when an electric current from a power source (not shown) is transmitted to the heating element 111 through the power cord 112, electric energy is converted into heat energy by the heating element 111, and the heat energy is transmitted from the heating core 13 to the soldering tip 15. Consequently, the temperature of the soldering tip 15 is increased. Under this circumstance, the tapered heating terminal 152 is heated to melt the solder. Consequently, an electronic component (not shown) is welded on a circuit board, or an electronic component is removed from the circuit board.

However, the applications of the conventional soldering iron 1 are usually restricted to the soldering process of the general circuit component. Nowadays, the surface mount component becomes the mainstream of the electronic components. In case that the conventional soldering iron 1 is used in the soldering process or the desoldering process of a surface mount component, the conventional soldering iron is not convenient.

In particular, while the soldering or desoldering process of the surface mount component is performed, the soldering iron is held by one hand of the user and a tweezers device is held by the other hand of the user. Since the volume of the surface mount component is very small and the number of the surface mount components to be processed is very large, it is usually necessary for the user to employ a desktop magnifier to check. If the user is not technically skilled or the soldering or desoldering process is carelessly performed, the surface mount component or the circuit board is readily suffered from damage. Under this circumstance, the quality of the welded product is usually unsatisfied. Therefore, the approach of using the soldering iron needs to be further improved.

### SUMMARY OF THE INVENTION

The present invention provides a tweezers device with a function of installing a soldering iron in order to facilitate the soldering or desoldering process of small-sized electronic components.

In accordance with an aspect of the present invention, there is provided a tweezers device with a function of installing a soldering iron. The tweezers device includes a first clipping structure and a second clipping structure. The first clipping structure includes a first clipping end. The second clipping structure is pivotally coupled to the first clipping structure, and includes an accommodation space and a second clipping end at an end of the accommodation space. When the second clipping structure is rotated relative to the first clipping structure and the second clipping end is moved toward the first clipping end, an object between the first clipping end and the second clipping end is clipped by the tweezers device. A soldering tip of the soldering iron is accommodated within the accommodation space. The second clipping end is made of a thermal conductive material. When the soldering tip is fixed within the accommodation space, the soldering tip is contacted with the second clipping end, so that a heat energy generated by the soldering iron is transferred to the second clipping end.

In accordance with another aspect of the present invention, there is provided a tweezers device with a function of installing a soldering iron. The tweezers device includes a first clipping structure and a second clipping structure. The first clipping structure includes a clipping end. The second clipping structure includes a tip enclosure and a soldering tip. The soldering tip is accommodated and fixed within the tip enclosure. The second clipping structure is pivotally coupled to the first clipping structure. When the second clipping structure is rotated relative to the first clipping structure and the soldering tip is moved toward the clipping end, an object between the clipping end and the soldering tip is clipped by the tweezers device. The tip enclosure is coupled with a tube carrier of the soldering iron by a connection mechanism, so that a heat energy generated by the soldering iron is transferred to the soldering tip.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates a conventional soldering iron;

FIG. 2 is a schematic exploded view illustrating the conventional soldering iron of FIG. 1;

FIG. 3 schematically illustrates a tweezers device with a function of installing a soldering iron according to a first embodiment of the present invention, in which a soldering iron is ready to be installed in the tweezers device;

FIG. 4 schematically illustrates the tweezers device of FIG. 3, in which the soldering iron is installed in the tweezers device;

FIG. 5 schematically illustrates the use of the tweezers device of FIG. 3 to clip an electronic component;

FIG. 6 schematically illustrates a tweezers device with a function of installing a soldering iron according to a second embodiment of the present invention, in which a soldering iron is ready to be installed in the tweezers device;

FIG. 7 schematically illustrates the tweezers device of FIG. 6, in which the soldering iron is installed in the tweezers device;

FIG. 8 schematically illustrates a tweezers device with a function of installing a soldering iron according to a third embodiment of the present invention, in which a soldering iron is ready to be installed in the tweezers device; and

FIG. 9 schematically illustrates the tweezers device of FIG. 8, in which the soldering iron is installed in the tweezers device.

### DETAILED DESCRIPTION OF THE PREFERRED EMBODIMENT

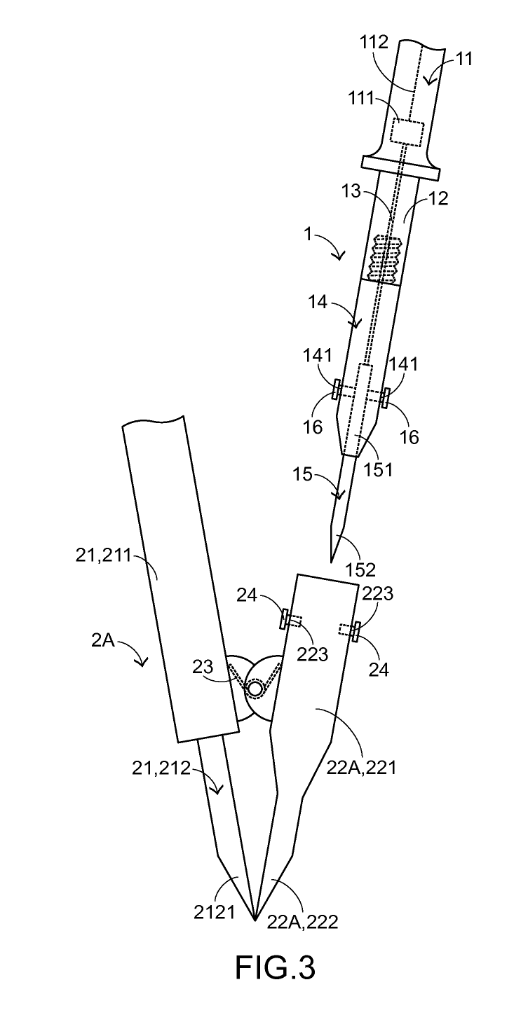

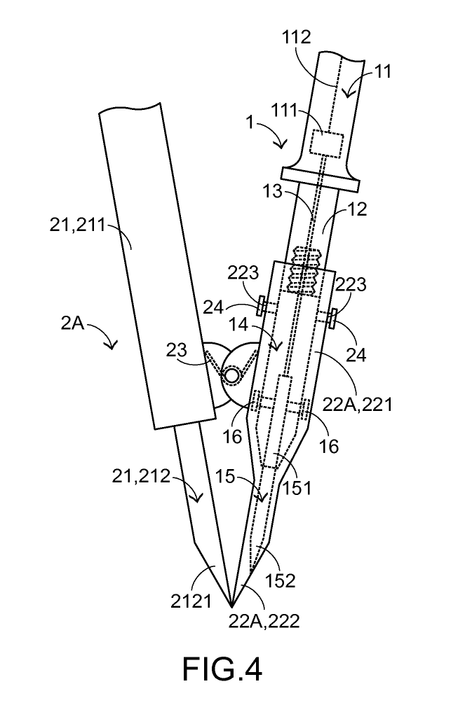

FIG. 3 schematically illustrates a tweezers device with a function of installing a soldering iron according to a first embodiment of the present invention, in which a soldering iron is ready to be installed in the tweezers device. FIG. 4 schematically illustrates the tweezers device of FIG. 3, in which the soldering iron is installed in the tweezers device. As shown in FIGS. 3 and 4, the tweezers device 2A comprises a first clipping structure 21, a second clipping structure 22A, and an elastic element 23. The second clipping structure 22A comprises an accommodation space 221 and a second clipping end 222. The second clipping end 222 is located at a bottom end of the accommodation space 221 and made of a thermal conductive material. The first clipping structure 21 comprises a handling part 211 and a clipping part 212. An end of the clipping part 212 is connected to the handling part 211, and the other end of the clipping part 212 is a first clipping end 2121.

The second clipping structure 22A is pivotally coupled to the first clipping structure 21. The elastic element 23 is located at the junction between the first clipping structure 21 and the second clipping structure 22A. An example of the elastic element 23 includes but is not limited to a torsion spring. The two ends of the elastic element 23 are sustained against the first clipping structure 21 and the second clipping structure 22A through an elastic force. Consequently, in case that no external force is applied to the tweezers device 2A, the first clipping end 2121 of the first clipping structure 21 and the second clipping end 222 of the second clipping structure 22A are contacted with each other and in a tightened status.

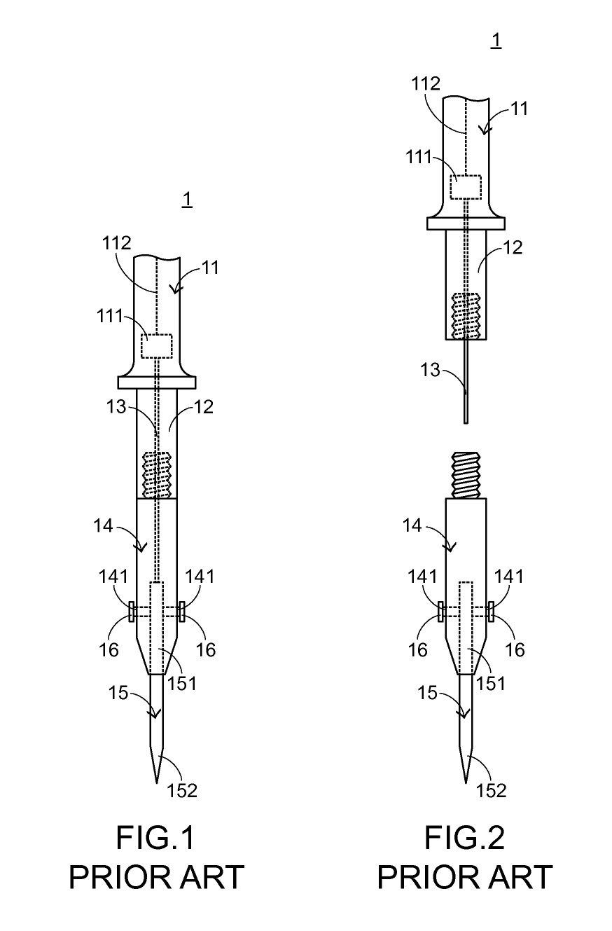

Moreover, a soldering iron 1 may be introduced into and accommodated within the accommodation space 221 of the second clipping structure 22A. The configurations of the soldering iron 1 are identical to those of the soldering iron 1 as shown in FIG. 1. Moreover, two perforations 223 are located at two opposite sides of the second clipping structure 22A. Two screws 24 are respectively penetrated through the two perforations 223 and contacted with two opposite sides of the tip enclosure 14 of the soldering iron 1 so as to fix the tip enclosure 14. Consequently, the soldering tip 15 of the soldering iron 1 is continuously contacted with the bottom end of the accommodation space 221 (i.e. the second clipping end 222 of the second clipping structure 22A). Since the second clipping end 222 of the second clipping structure 22A is made of the thermal conductive material, the heat energy from the soldering tip 15 may be transferred to the second clipping end 222. After the temperature of the second clipping end 222 is increased, the second clipping end 222 is heated to melt the solder. Consequently, the soldering or desoldering process may be implemented. The way of fixing the soldering iron is presented herein for purpose of illustration and description only. However, those skilled in the art will readily observe that numerous modifications and alterations may be made while retaining the teachings of the invention.

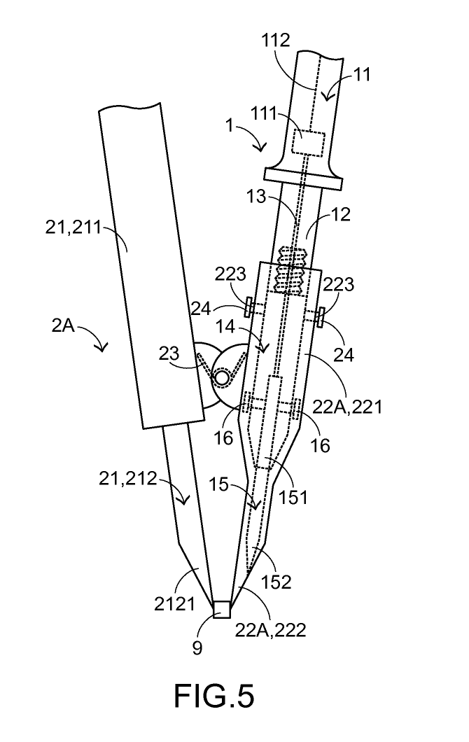

FIG. 5 schematically illustrates the use of the tweezers device of FIG. 3 to clip an electronic component. For performing a soldering or desoldering process of a small-sized electronic component 9, the commercially available soldering iron 1 (see FIG. 1) for soldering the general electronic component is firstly placed into the second clipping structure 22A of the tweezers device 2A, and then the soldering iron 1 is fixed in the second clipping structure 22A by fastening means. After the soldering iron 1 is turned on, the temperature at the second clipping end 222 of the second clipping structure 22A is increased. Then, by grasping the handling part 211 of the first clipping structure 21 and the soldering iron handle 11 of the soldering iron 1, the second clipping structure 22A and the first clipping structure 21 are rotated with each other, so that the first clipping end 2121 of the first clipping structure 21 and the second clipping end 222 of the second clipping structure 22A are separated from each other. Then, the electronic component 9 to be clipped is arranged between the first clipping end 2121 and the second clipping end 222. When the handling part 211 of the first clipping structure 21 and the soldering iron handle 11 of the soldering iron 1 are no longer grasped by the user, in response to the elastic force provided by the elastic element 23, the second clipping structure 22A and the first clipping structure 21 are rotated with each other, so that the second clipping end 222 and the first clipping end 2121 are moved toward each other. Consequently, the electronic component 9 between the first clipping end 2121 and the second clipping end 222 is clipped by the first clipping end 2121 and the second clipping end 222. Since the temperature at the second clipping end 222 is able to melt the solder at this moment, the electronic component 9 clipped by the tweezers device 2A may be welded on a circuit board (not shown), or the electronic component 9 clipped by the tweezers device 2A may be removed from the circuit board.

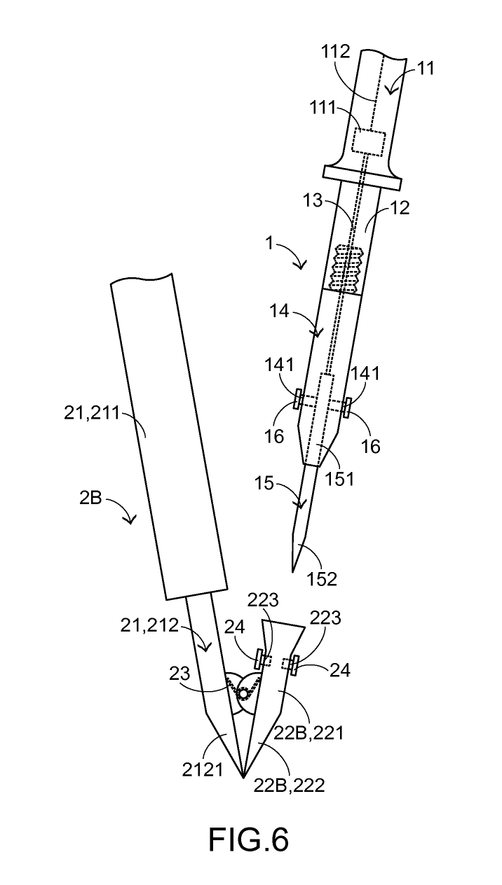

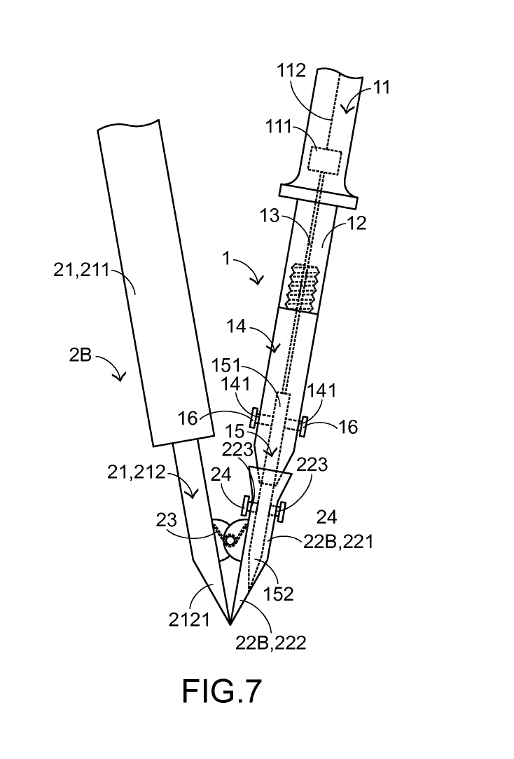

FIG. 6 schematically illustrates a tweezers device with a function of installing a soldering iron according to a second embodiment of the present invention, in which a soldering iron is ready to be installed in the tweezers device. FIG. 7 schematically illustrates the tweezers device of FIG. 6, in which the soldering iron is installed in the tweezers device. Please refer to FIGS. 6 and 7. Except for the following aspects, the components of the tweezers device 2B of this embodiment are similar to those of the tweezers device 2A of the first embodiment, and are not redundantly described herein. In comparison with the first embodiment, the second clipping structure 22B of the tweezers device 2B is shorter. When the soldering iron 1 is installed in the tweezers device 2B, two screws 24 are contacted with two opposite sides of the soldering tip 15 of the soldering iron 1 so as to fix the soldering tip 15. Consequently, the soldering tip 15 of the soldering iron 1 is continuously contacted with the bottom end of the accommodation space 221 (i.e. the second clipping end 222 of the second clipping structure 22B).

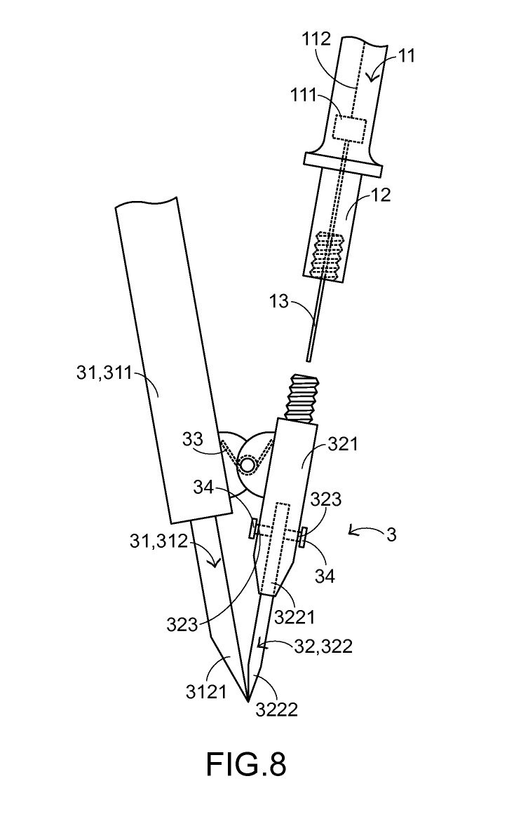

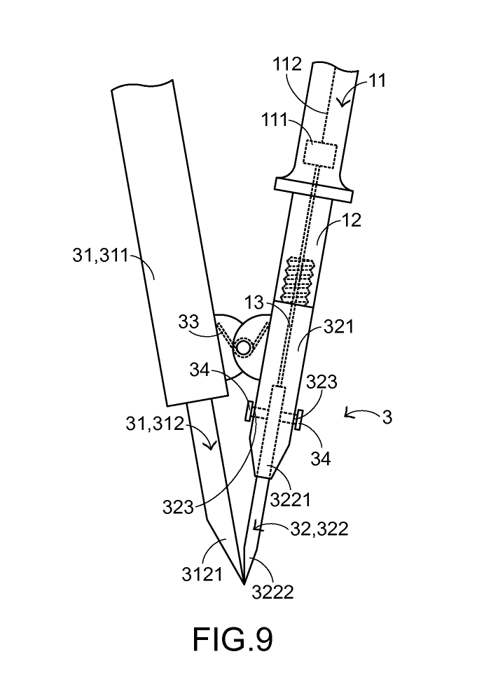

FIG. 8 schematically illustrates a tweezers device with a function of installing a soldering iron according to a third embodiment of the present invention, in which a soldering iron is ready to be installed in the tweezers device. FIG. 9 schematically illustrates the tweezers device of FIG. 8, in which the soldering iron is installed in the tweezers device. As shown in FIGS. 8 and 9, the tweezers device 3 comprises a first clipping structure 31, a second clipping structure 32, and an elastic element 33. The first clipping structure 31 comprises a handling part 311 and a clipping part 312. The second clipping structure 32 comprises a tip enclosure 321 and a soldering tip 322. An end of the clipping part 312 is connected to the handling part 311, and the other end of the clipping part 312 is a clipping end 3121. The soldering tip 322 comprises an installation terminal 3221 and a tapered heating terminal 3222. The installation terminal 3221 is accommodated within the tip enclosure 321. The tapered heating terminal 3222 is penetrated through the tip enclosure 321 and exposed outside the tip enclosure 321. Moreover, two perforations 323 are located at two opposite sides of the tip enclosure 321. Two screws 34 are respectively penetrated through the two perforations 323 and contacted with two opposite sides of the installation terminal 3221 of the soldering tip 322. After the soldering tip 322 is fixed by the two screws 34, the soldering tip 322 is not detached from the tip enclosure 321. The way of fixing the soldering iron is presented herein for purpose of illustration and description only. However, those skilled in the art will readily observe that numerous modifications and alterations may be made while retaining the teachings of the invention.

The second clipping structure 32 is pivotally coupled to the first clipping structure 31. The elastic element 33 is located at the junction between the first clipping structure 31 and the second clipping structure 32. An example of the elastic element 33 includes but is not limited to a torsion spring. The two ends of the elastic element 33 are sustained against the first clipping structure 31 and the second clipping structure 32 through an elastic force. Consequently, in case that no external force is applied to the tweezers device 3, the clipping end 3121 of the first clipping structure 31 and the tapered heating terminal 3222 of the soldering tip 322 are contacted with each other and in a tightened status.

Moreover, the tip enclosure 321 of the second clipping structure 32 may be coupled with the tube carrier 12 of a mating soldering iron (e.g. the soldering iron 1 as shown in FIG. 1) by a connection mechanism (e.g. a screwing connection mechanism). After the tube carrier 12 and the tip enclosure 321 are coupled with each other, the heating core 13 is contacted with the installation terminal 3221 of the soldering tip 322. Moreover, when an electric current passes through the soldering iron 1, electric energy is converted into heat energy, and the heat energy is transmitted from the heating core 13 to the soldering tip 322 of the second clipping structure 32. Consequently, the temperature of the soldering tip 322 is increased. Under this circumstance, the tapered heating terminal 3222 of the soldering tip 322 is heated to melt the solder during the soldering or desoldering process.

For performing a soldering or desoldering process of a small-sized electronic component 9, the commercially available soldering iron 1 (see FIG. 1) for soldering the general electronic component is firstly disassembled. Then, the combination of the soldering iron handle 11 and the tube carrier 12 disassembled from the soldering iron 1 is coupled with the tip enclosure 321 of the second clipping structure 32. After the soldering iron 1 is turned on, the temperature at the soldering tip 322 of the second clipping structure 32 is increased. Then, by grasping the handling part 311 of the first clipping structure 31 and the soldering iron handle 11 of the soldering iron 1, the second clipping structure 32 and the first clipping structure 31 are rotated with each other, so that the clipping end 3121 of the first clipping structure 31 and the soldering tip 322 of the second clipping structure 32 are separated from each other. Then, the electronic component 9 to be clipped is arranged between the clipping end 3121 and the soldering tip 322. When the handling part 311 of the first clipping structure 31 and the soldering iron handle 11 of the soldering iron 1 are no longer grasped by the user, in response to the elastic force provided by the elastic element 33, the second clipping structure 32 and the first clipping structure 31 are rotated with each other, so that the soldering tip 322 and the clipping end 3121 are moved toward each other. Consequently, the electronic component 9 between the soldering tip 322 and the clipping end 3121 is clipped by the soldering tip 322 and the clipping end 3121. Since the temperature at the soldering tip 322 is able to melt the solder at this moment, the electronic component 9 clipped by the tweezers device 3 may be welded on a circuit board (not shown), or the electronic component 9 clipped by the tweezers device 3 may be removed from the circuit board.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A tweezers device with a function of installing a soldering iron, the tweezers device comprising:
a first clipping structure comprising a first clipping end; and
a second clipping structure pivotally coupled to the first clipping structure, and comprising an accommodation space and a second clipping end at an end of the accommodation space, wherein when the second clipping structure is rotated relative to the first clipping structure and the second clipping end is moved toward the first clipping end, an object between the first clipping end and the second clipping end is clipped by the tweezers device,
wherein a soldering tip of the soldering iron is accommodated within the accommodation space, and the second clipping end is made of a thermal conductive material, wherein when the soldering tip is fixed within the accommodation space, the soldering tip is contacted with the second clipping end, so that a heat energy generated by the soldering iron is transferred to the second clipping end.

2. The tweezers device according to claim 1, further comprising an elastic element, wherein the elastic element is arranged between the first clipping structure and the second clipping structure and provides an elastic force, wherein in response to the elastic force, the second clipping structure is rotated relative to the first clipping structure, so that the second clipping end is moved toward the first clipping end.

3. The tweezers device according to claim 1, wherein the first clipping structure comprises a handling part and a clipping part, wherein the first clipping end is located at a first end of the clipping part, and the handling part is connected to a second end of the clipping part.

4. The tweezers device according to claim 1, wherein two perforations are located at two opposite sides of the second clipping structure, and the second clipping structure further comprises two screws, wherein the two screws are respectively penetrated through the two perforations and contacted with two opposite sides of the soldering tip within the accommodation space, so that the soldering tip is fixed in the accommodation space.

5. The tweezers device according to claim 1, wherein the soldering iron converts an electric energy into the heat energy, wherein the soldering iron comprises a soldering iron handle, a tube carrier, a heating core, a tip enclosure and a soldering tip, wherein the tube carrier is connected to the soldering iron handle, and at least a part of the heating core is accommodated within the tube carrier, wherein the soldering tip is accommodated and fixed within the tip enclosure, and the tip enclosure is coupled with the tube carrier by a connection mechanism, so that the heating core is contacted with the soldering tip, wherein two perforations are located at two opposite sides of the second clipping structure, and the second clipping structure further comprises two screws, wherein the two screws are respectively penetrated through the two perforations and contacted with the tip enclosure within the accommodation space, so that the tip enclosure and the soldering tip are fixed in the accommodation space.

6. The tweezers device according to claim 1, wherein the object is a surface mount component.

7. A tweezers device with a function of installing a soldering iron, the tweezers device comprising:
a first clipping structure comprising a clipping end; and
a second clipping structure comprising a tip enclosure and a soldering tip, wherein the soldering tip is accommodated and fixed within the tip enclosure, wherein the second clipping structure is pivotally coupled to the first clipping structure, wherein when the second clipping structure is rotated relative to the first clipping structure and the soldering tip is moved toward the clipping end, an object between the clipping end and the soldering tip is clipped by the tweezers device,
wherein the tip enclosure is coupled with a tube carrier of the soldering iron by a connection mechanism, so that a heat energy generated by the soldering iron is transferred to the soldering tip.

8. The tweezers device according to claim 7, further comprising an elastic element, wherein the elastic element is arranged between the first clipping structure and the second clipping structure and provides an elastic force, wherein in response to the elastic force, the second clipping structure is rotated relative to the first clipping structure, so that the soldering tip is moved toward the clipping end.

9. The tweezers device according to claim 7, wherein the first clipping structure comprises a handling part and a clipping part, wherein the clipping end is located at a first end of the clipping part, and the handling part is connected to a second end of the clipping part.

10. The tweezers device according to claim 7, wherein two perforations are located at two opposite sides of the tip enclosure, and the tip enclosure further comprises two screws, wherein the two screws are respectively penetrated through the two perforations and contacted with two opposite sides of the soldering tip within the accommodation space, so that the soldering tip is fixed in the accommodation space.

11. The tweezers device according to claim 7, wherein the object is a surface mount component.

12. The tweezers device according to claim 7, wherein the connection mechanism is a screwing connection mechanism.
